(19) United States
(12) Patent Application Publication
(10) Pub. No.: US 2025/0301058 A1
(43) Pub. Date: Sep. 25, 2025

(54) SPLIT-LEVEL PROCESSING OF NETWORK PACKETS USING HARDWARE CIRCUITRY

(71) Applicant: Chelsio Communications, Inc., Sunnyvale, CA (US)

(72) Inventors: Balekudru Krishna, Sunnyvale, CA (US); John Hanel, Sunnyvale, CA (US)

(21) Appl. No.: 18/613,982

(22) Filed: Mar. 22, 2024

(51) Int. Cl. H04L 69/22; H04L 49/901

(52) U.S. Cl. CPC H04L 69/22; H04L 49/901

(57) ABSTRACT

A method and apparatus which is dedicated to the parsing of variable length tokens, a multitude of which may be present within individual networking packets in a split-level fashion are described. The techniques may utilize parallel circuits to (1) parse out the “high-level” header information to determine a type of token as well as distinct byte boundaries of individual tokens within the networking packet; and (2) parse and process the data present within each extracted token's boundaries. Such split-level, parallel parsing is beneficial to manage design complexity, enable better performance and testability of devices and systems.

### TECHNICAL FIELD

The present disclosure relates generally to the field of computer networking circuitry, and more particularly to circuitry for parsing network packets.

### BACKGROUND

Computer networks are generally a group of computers or other devices that are communicatively connected and use one or more communication protocols to exchange data, such as by using packet switching. For instance, computer networking can refer to connected computing devices (such as laptops, desktops, servers, smartphones, and tablets) as well as an ever-expanding array of Internet-of-Things (IoT) devices (such as cameras, door locks, doorbells, refrigerators, audio/visual systems, thermostats, and various sensors) that communicate with one another. Modern-day networks deliver various types of networks, such as Local-Area Networks (LANs) that are in one physical location such as a building, Wide-Area Networks (WANs) that extend over a large geographic area to connect individual users or LANs, Enterprise Networks that are built for a large organization, Internet Service Provider (ISP) Networks that operate WANs to provide connectivity to individual users or enterprises, software-defined networks (SDNs), wireless networks, core networks, cloud networks, and so forth.

In computer networking, network devices may receive data packets whose formats are dictated by protocol rules. For instance, in certain protocols, individual packets may consist of multiple tokens, each of which consists of a fixed sized header and may be of variable total length. Traditionally, when a circuit receives a data packet, the circuit would parse through each packet and process each token one at a time. However, doing so is not only time consuming but also inefficient, leading to inefficient use of network resources and poor network performance. Moreover, traditional techniques lack testability when troubleshooting.

Accordingly, there exists a need to provide a way to optimize parsing of variably sized tokens that also optimizes testability.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system-architecture diagram of an environment in which a token processing system can perform split-level processing on network packet(s).

FIG. 2A illustrates example environment including a network packet that is processed by the token processing system 106 of FIG. 1

FIG. 2B illustrates example outputs associated with the system of FIGS. 1 and 2A.

FIG. 3 illustrates a flow diagram of an example system for a high-level parser to perform processing of network packet(s) in parallel with low-level parser(s), in accordance with the systems and techniques described in FIGS. 1-2.

FIG. 4 illustrates a flow diagram of an example system for a low-level parser to process token(s) and provide output in parallel with a high-level parser, in accordance with the systems and techniques described in FIGS. 1-3

FIG. 5 illustrates a flow diagram of an example method for a system to perform split-level processing of network packet(s) according to the techniques described in FIGS. 1-4.

FIG. 6 is a computer architecture diagram showing an illustrative computer hardware architecture for implementing a device that can be utilized to implement aspects of the various technologies presented herein.

FIG. 7 illustrates a block diagram illustrating certain components of an example node that can be utilized to implement various aspects of the technologies disclosed herein.

### DESCRIPTION OF EXAMPLE EMBODIMENTS

### Overview

The present disclosure relates generally to techniques for providing a hardware circuit that is designed to parse network packets which consist of multiple variable sized tokens.

A method to perform techniques described herein may be implemented at least in part by hardware processing circuitry. The techniques may include receiving a network protocol packet comprising a plurality of tokens. The techniques identifying, by a first parser, a first token of the plurality of tokens. Additionally, the techniques include determining, by the first parser, first boundaries of the first token, the first boundaries including a first token type. The techniques further include triggering, by the first parser and based on the first token type, a second parser. The techniques may also include identifying, by the first parser, a second token of the plurality of tokens. Further, the techniques may include determining, by the first parser, second boundaries of the second token, the second boundaries including a second token type. The techniques may include triggering, by the first parser and based on the second token type, a third parser.

Additionally, the techniques described herein may be performed by a system and/or device having non-transitory computer-readable media storing computer-executable instructions that, when executed by one or more processors, performs the method described above.

### EXAMPLE EMBODIMENTS

Computer networks are generally a group of computers or other devices that are communicatively connected and use one or more communication protocols to exchange data, such as by using packet switching. For instance, computer networking can refer to connected computing devices (such as laptops, desktops, servers, smartphones, and tablets) as well as an ever-expanding array of Internet-of-Things (IoT) devices (such as cameras, door locks, doorbells, refrigerators, audio/visual systems, thermostats, and various sensors) that communicate with one another. Modern-day networks deliver various types of networks, such as Local-Area Networks (LANs) that are in one physical location such as a building, Wide-Area Networks (WANs) that extend over a large geographic area to connect individual users or LANs, Enterprise Networks that are built for a large organization, Internet Service Provider (ISP) Networks that operate WANs to provide connectivity to individual users or enterprises, software-defined networks (SDNs), wireless networks, core networks, cloud networks, and so forth.

In computer networking, network devices may receive data packets whose formats are dictated by protocol rules. For instance, in certain protocols, individual packets may consist of multiple tokens, each of which consists of a fixed sized header and may be of variable total length. Traditionally, when a circuit receives a data packet, the circuit would parse through each packet and process each token one at a time. However, doing so is not only time consuming but also inefficient, leading to inefficient use of network resources and poor network performance. Moreover, traditional techniques lack testability when troubleshooting.

Accordingly, there exists a need to provide a way to optimize parsing of variably sized tokens that also optimizes testability.

This disclosure describes techniques and mechanisms for providing a circuit that is designed to parses network packets which consist of multiple variable sized tokens, each with a fixed sized header and with a variable number of bytes of data in its body. For instance, the techniques may comprise receiving a network protocol packet comprising a plurality of tokens; identifying, by a first parser, a first token of the plurality of tokens; determining, by the first parser, first boundaries of the first token, the first boundaries including a first token type; triggering, by the first parser and based on the first token type, a second parser; identifying, by the first parser, a second token of the plurality of tokens; determining, by the first parser, second boundaries of the second token, the second boundaries including a second token type; and triggering, by the first parser and based on the second token type, a third parser.

In some examples, each network packet may comprise a plurality of tokens, each of which may vary in size. In some examples, each token comprises a token type, a length associated with each token, and a number of data bytes (e.g., zero data bytes, or any suitable value of data bytes). In some examples, the length of a token can either be implicit (understood and derived from the “type” or KIND of header) or explicit (with the length specified within a certain field inside the header).

In some examples, the system utilizes a dedicated hardware circuit to parse the data packets, where the circuit is explicitly designed for parsing the variably sized tokens, while being optimized for parallelism and testability.

In computer networking, it is quite common for network protocol packets to contain one or more tokens within them, with each token consisting of a fixed sized header, and a variably sized body (or data bytes). There is a list of known types of such tokens, each identified by a header type, and associated with which is a known length. The length can either be implicit (understood and derived from the “type” or KIND of header) or explicit (with the length specified within a certain field inside the header). When such network protocol packets arrive, these need to be parsed, either in hardware or software. This parser traverses the bytes within a network packet, first identifies the type of token it sees, then derives its length and separates out the control information (header) from the data information (from the token's body). For instance, once a token is identified, and its individual constituents are separated, the data embedded might need to be presented as such, or ignored, or processed based on contents.

Accordingly, by utilizing dedicated hardware circuitry and split-level processing, the techniques described herein provide accelerated parsing of network packets and improve efficiency within networks.

In some examples, the system utilizes split-level processing. For instance, the system may comprise a high-level parser. In some examples, the high-level parser corresponds to a high-level parser thread. In some examples, the high-level parser thread processes the header of the network packet to (1) identify a token type associated with a token and (2) determine boundaries associated with each token. In some examples, the high-level parser may comprise a byte pointer that may be used to parse the network packet and identify boundaries (e.g., start point, end point, pointers, length, etc.) of token(s). In some examples, the high-level parser may internally maintain the byte pointer. When a network packet is received, the high-level parser may reset the byte pointer to byte 0 within a packet buffer. Accordingly, this data structure tracks the progress of the bytes parsed within each incoming network packet, which accumulates in a packet buffer.

In some examples, the token types (e.g., KINDs, such as KINDx, KINDy, KINDz, etc.) may each comprise a respective predetermined length. In some examples, the high-level parser may compare a token type indicated in the header of the network packet to the KINDs (e.g., such as a list stored in memory), and match the token type to a particular KIND. In some examples, such as where the high-level parser determines a token in an incoming packet does not match the known list of KINDs, the high-level parser may treat the token type as an unknown KIND, where the token may comprise an arbitrarily length (e.g., such as a length specified within the header).

In some examples, the system may comprise one or more low-level parsers. In some examples the low-level parser(s) may comprise per-token parser threads. For instance, the low-level parser(s) may each be assigned and/or associated with a token type. As an example, there may be one low-level token per token KIND (i.e., a first low-level parser associated with per-token KINDx parser, a second low-level parser associated with per-token KINDy parser, a third low-level parser associated with per-token KINDz parser, etc.). In some examples, the token type(s) correspond to one or more transmission control protocol (TCP) options (e.g., such as maximum segment size, window scaling, timestamp(s), etc.). In some examples, the low-level parser(s) also comprise a single per-token parser for the purpose of processing unknown KIND token types, of arbitrary lengths. In some examples, the low-level parser processes the boundaries of the token in parallel with the high-level parser. For instance, a first low-level parser may process a first token. At the same time, the high-level parser may trigger a second low-level parser associated with a second token type when a second token is identified. The second low-level parser may process the second token in parallel with the first low-level parser and while the high-level parser continues to parse the network packet.

In some examples, the high-level parser may trigger a low-level parser. For instance, when the high-level parser identifies a token, the high-level parser may identify a low-level parser associated with a token type corresponding to the token. The high-level parser may trigger the low-level parser to process the token by providing input to the low-level parser. In some examples, the input may comprise the boundaries (e.g., size, start point, end point, etc.) of the token. In some examples, the high-level parser does not process the contents of the token.

In some examples, the high-level parser may determine that an end of the network packet is reached. In this example, the high-level parser may assert an “input done” trigger to the one or more low-level parsers. For instance, the high-level parser may transmit the input done trigger to each of the low-level parsers, where the input done trigger indicates that the end of the network packet is reached and instructs the low-level parsers to provide respective output(s) when ready (e.g., when each token is processed).

In some examples, each low-level parser may output a trigger to indicate that processing of the respective token data is complete. For instance, each low-level parser may assert a “token done” trigger (e.g., KIND_done) to indicate that it has it has completed its processing. In some examples, the low-level parser(s) may output one or more value(s) associated with the processed token contents. For instance, a first low-level parser may output a single value and a second low-level parser may output two or more values. In some examples, each of the low-level parser(s) may output a bit that indicates whether an associated token type is seen within a network packet.

As an example, a low-level parser may comprise a maximum segment size (MSS) option parser and may operate on a first token identified within a network packet. When the low-level parser receives the input done trigger from the high-level parser, the low-level parser may finish processing the first token and may output a number between 0-9000, indicating the maximum size of TCP packet to expect in the future. In some examples, the low-level parser may also output a bit that comprises a value indicating whether the token type associated with the first low-level parser was seen within the network packet. In this example, the bit may comprise a value indicating that the MSS token type was seen within the network packet. In some examples, such as where the low-level parser (e.g., the MSS option parser) is not triggered by the high-level parser to operate on a token, the low-level may still receive the input done trigger from the high-level parser. In this example, the low-level parser may output a bit indicating that the token type (e.g., MSS option) associated with the low-level parser was not seen within the network packet.

In some examples, the system may aggregate the output values. Where outputs indicate that one or more token types were not seen within a network packet, the system may insert default values. In some examples, the system may send the aggregated values to a next level of processing to enable the system to perform various actions (e.g., such as updating a state of the TCP, etc.). For instance, when all the low-level parsers have completed processing the token data (e.g., asserted their KIND_done output signals), the system may consume the outputs. In some examples, the high-level parser is then free to process the next network packet which is then allowed to stream into the packet buffer.

In some examples, the system may be extended to “nest” multiple levels of parsing. In other words, the system may enable a particular per-token parser to itself be a high-level parser with its own sub-per-token parsers within it. Such a recursive implementation of this method lends itself naturally to the parsing of multiple levels of network protocol packets, where we have one high-level parser per level of network protocol.

In this way, the system may perform overall parsing of incoming network packets by coordinating the high-level parser with various individual per-token parser. Such split-level, parallel parsing enables improved performance of network devices and offers optimized pipelining possibilities within hardware designs. Moreover, by providing parallel process, verification of high-level and low-level processing is simplified, thereby improving testability.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

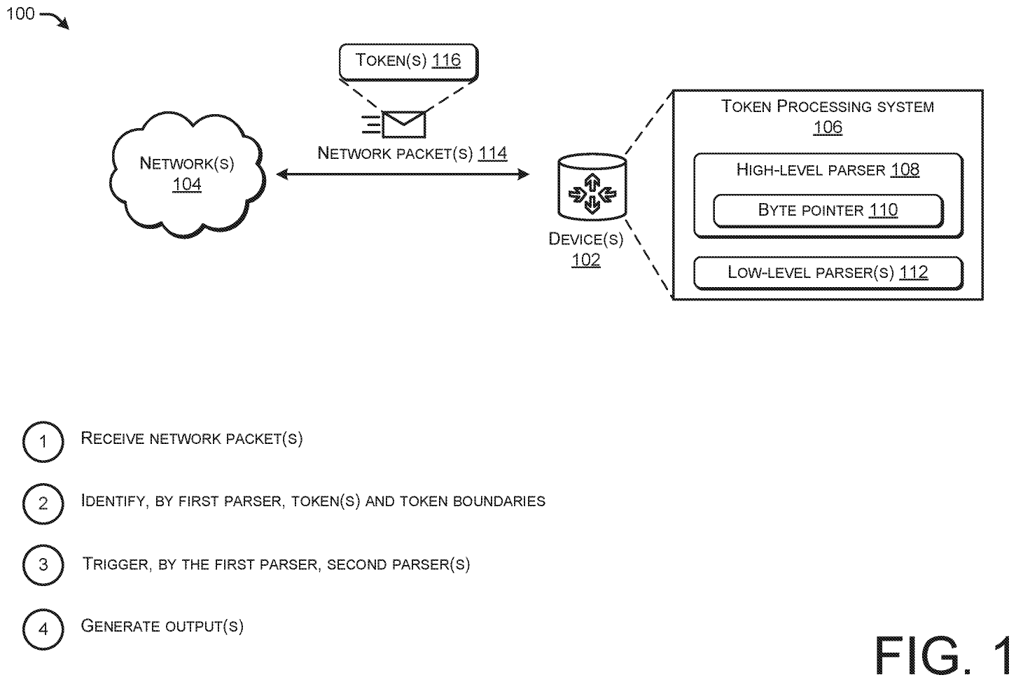

FIG. 1 illustrates a system-architecture diagram of an environment 100 in which a token processing system 106 can perform split-level processing on network packet(s) 114. The environment may include device(s) 102, which may correspond to one or more network devices. In some examples, device(s) 102 may comprise a router, a switch, and/or any other type of device included in a network architecture.

In some examples, the device(s) 102 are configured to receive network packet(s) 114 via network(s) 104. In some examples, the network packet(s) 114 comprise a header of a fixed size and plurality of token(s) 116. In some examples, the device(s) 102 receive the network packet(s) 114 as a stream and may accumulate the network packet(s) 114 in a packet buffer. In some examples, each token 116 may vary in size (e.g., vary in the number of bytes of data in the body of the token). In some examples, each token 116 comprises a token type, a length associated with each token, and a number of data bytes (e.g., zero data bytes, or any suitable value of data bytes). In some examples, the length of a token 116 can either be implicit (understood and derived from the “type” or KIND of header) or explicit (with the length specified within a certain field inside the header).

In some examples, the device(s) 102 comprise a token processing system 106. In some examples, the token processing system 106 corresponds to hardware circuitry designed to perform the techniques described herein. As illustrated, the token processing system 106 may comprise one or more of a high-level parser 108 and low-level parser(s) 112. In some examples, the high-level parser 108 corresponds to a high-level parser thread. In some examples, the high-level parser 108 is configured to process the header of the network packet to (1) identify a token type associated with a token and (2) determine boundaries or pointers associated with each token within a network packet.

In some examples, the high-level parser may comprise a byte pointer 110. In some examples, the byte pointer 110 may parse the network packet and identify boundaries (e.g., start point, end point, length, body size, etc.) of token(s). In some examples, the high-level parser 108 may internally maintain the byte pointer 110. For instance, when a network packet is received, the high-level parser 108 may reset the byte pointer 110 to byte 0 within a packet buffer. Accordingly, this data structure tracks the progress of the bytes parsed within each incoming network packet, which accumulates in a packet buffer.

In some examples, the environment 100 may include a network 104 that may comprise a service network includes devices housed or located in one or more data centers. The network 104 may include one or more networks implemented by any viable communication technology, such as wired and/or wireless modalities and/or technologies. The network 104 may include any combination of Personal Area Networks (PANs), Local Arca Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The network 104 may include devices, virtual resources, or other nodes that relay packets from one network segment to another by nodes in the computer network. The network 104 may include multiple devices that utilize the network layer (and/or session layer, transport layer, etc.) in the OSI model for packet forwarding, and/or other layers.

In some instances, the device(s) 102 may be included as part of the network 104. The network 104 may generally include, manage, or otherwise be associated with one or more applications or services utilized by users. The network 104 may provide any type of application or service for use by users of client devices (not shown). However, in other instances the device(s) 102 may be associated with any type of computing device and be used for any purpose.

At “1”, the system may receive network packet(s). For instance, the network packet(s) may correspond to network packet(s) 114. In some examples, when a new packet starts to stream into the packet buffer of the token processing system 106, a high-level parser 108 may identify a token type (e.g., a “KIND”) byte associated with a token. In some examples, the token type byte may correspond to a first byte in the header of a network packet. In some examples, the high-level parser 108 may determine whether the token type is a known token type based on comparing the token type to a stored list on known token types. The high-level parser 108 may then examine the second byte in the header, which may comprise a length associated with the token.

At “2”, the system may identify, by a first parser, token(s) and token boundaries. For instance, the first parser may comprise a high-level parser 108. In some examples, such as where the high-level parser determines that a length field of a token matches an internal notion of the length associated with this particular token type, the high-level parser may then determine boundaries of the token. For instance, the first parser may identify the <lo_ptr,hi_ptr> which define the byte boundaries of this particular token within the packet buffer. In some examples, the token type(s) correspond to one or more transmission control protocol (TCP) options (e.g., such as maximum segment size, window scaling, timestamp(s), etc.).

At “3” the system may trigger, by the first parser, second parser(s). For instance, the first parser may trigger a second parser based on the token type. In some examples, the first parser may identify the second parser by comparing the token type to a list of known token types stored in memory of the system and identifying a correlated low-level parser. The second parser(s) may comprise low-level parser(s) 112. In some examples, after identifying the token type, the first parser may trigger the second parser associated with the identified token type (e.g., KIND) by asserting a trigger (e.g., such as “KIND_trigger”). The first parser may transmit the token boundaries (e.g., the pointers associated with this token's boundaries) to the second parser(s).

In some examples, such as where the token type does not match the list of known token types, then a KIND_trigger is sent to a second parser that is dedicated to handling “unknown” tokens and the length is derived from the header of that token. In this example, the second parser does not perform processing on the data portion of the token, such that processing of the token is skipped over.

In some examples, when the second parser receives the trigger, the second parser begins to process the bytes of the token, as defined by the transmitted token boundaries (e.g., <lo_ptr,hi_ptr> within the packet buffer). In some examples, processing of data bytes within each token may vary based on token type.

In some examples, after triggering the second parser and while the second parser is processing the token, the first parser may continue parsing the network packet 114. For instance, the first parser may update byte pointer 110 to a value equal to the previous token's Hi_ptr+/within the current network packet, if it exists. On the other hand, if there is no other token present within this current network packet and if the byte_ptr reaches the end of the packet, the high-level parser asserts Inp_done which is broadcast to all the per-token parsers as an indication that no more per-token triggers will be generated for this particular packet.

At “4”, the system may generate output(s). For instance, the first parser may send an “input done” trigger to the second parser(s) when the end of the network packet 114 is reached. The input done trigger may indicate that no more triggers will be generated for this particular network packet 114. In response, the second parser(s) may complete processing of the respective token data and may provide outpu(s).

In some examples, each low-level parser may output a trigger to indicate that processing of the respective token data is complete. For instance, each low-level parser may assert a “token done” trigger (e.g., KIND_done) to indicate that it has it has completed its processing. In some examples, the low-level parser(s) may output one or more value(s) associated with the processed token contents. For instance, a first low-level parser may output a single value and a second low-level parser may output two or more values. In some examples, each of the low-level parser(s) may output a bit that indicates whether an associated token type is seen within a network packet.

In this way, the system provides a decomposed way of performing network protocol parsing using split-levels. For instance, by enabling the “high level” and “low-level” parsers to operate in parallel, the system provides improved performance and enables pipelining possibilities within hardware designs. Moreover, testing or verification of the system may now be decomposed into sub-units. For instance, a testing subunit that exercises the “high level” parser can generate various possible token headers, treating the data bytes as don't-cares. As long as the high-level parser extracts the header and the pointers defining each token correctly, the data can be treated as irrelevant at this level of testing and verification. Meanwhile, each low-level parser can be individually tested within a separate sub-unit where all variations of this specific type of token can be tested in isolation, thereby improving testability.

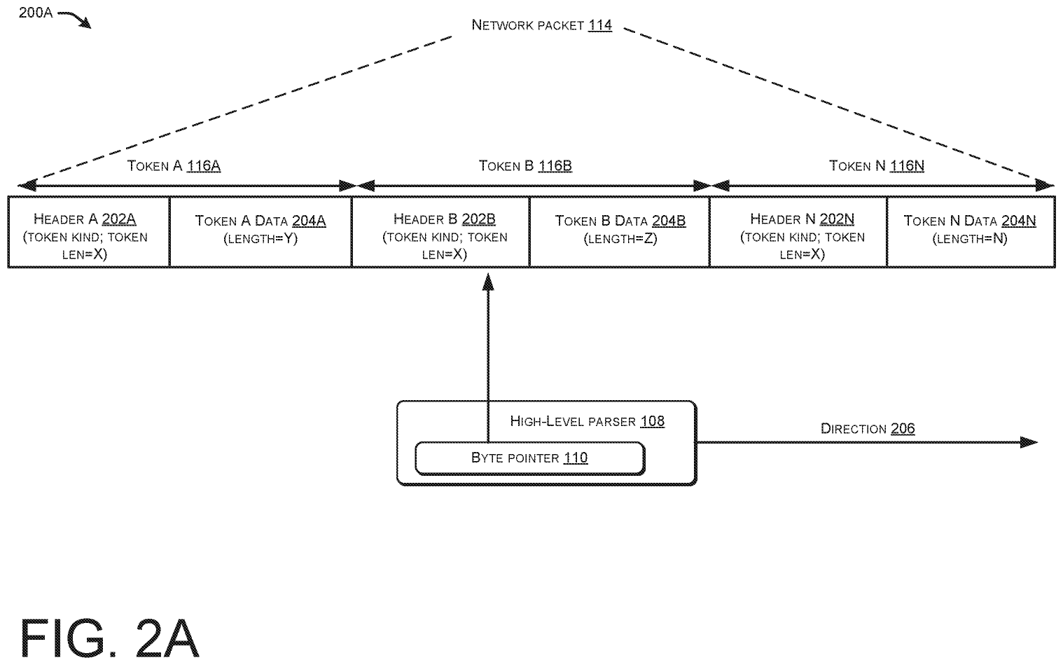

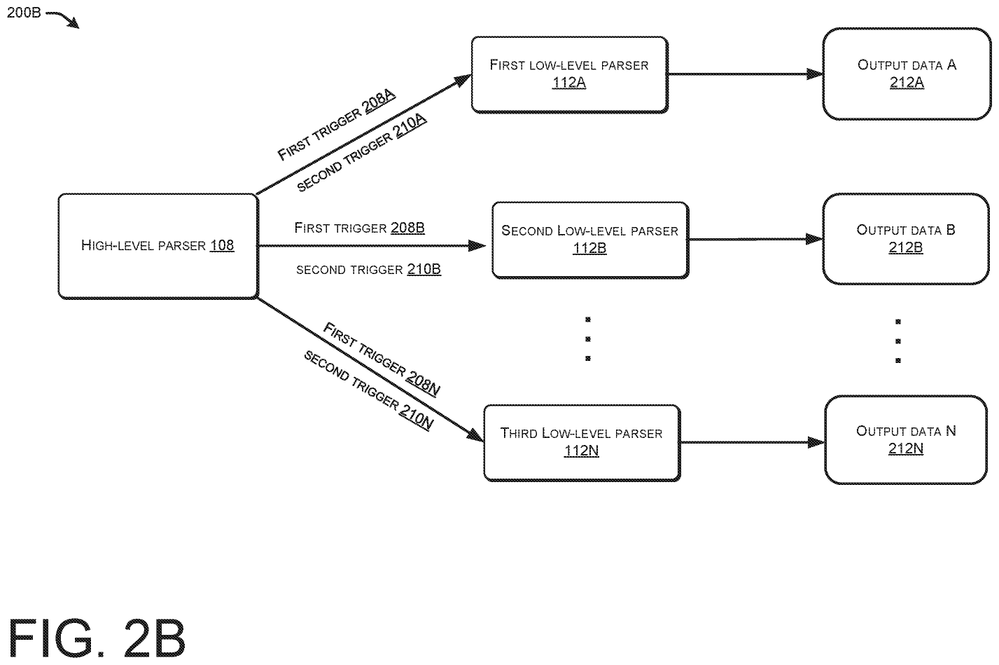

FIG. 2A illustrates an example environment 200A including a network packet 114 that is processed by the token processing system 106 of FIG. 1. in some examples, the network packet 114 is received and/or streamed into a packet buffer of the device 102 and/or token processing system 106. As illustrated, the environment 200A may comprise high-level parser 108, byte pointer 110, and network packet 114.

As illustrated, the network packet 114 may include token(s) 116. For instance, the network packet 114 may comprise a token A 116A, token B 116B, . . . token N 116N. As illustrated in FIG. 2A, each token 116 may comprise respective header(s) and bodies. For instance, token A 116A may comprise header A 202A, which may include a token type and/or indication of token length (illustrated as token LEN=X). Token A 116A may further comprise a body, illustrated as token A data 204A, which may include an indication of byte length (illustrated as length=Y). Token B 116B may comprise header B 202B, which may include a token type and/or indication of token length (illustrated as token LEN=X). Token B 116B may further comprise a body, illustrated as token B data 204B, which may include an indication of byte length (illustrated as length=Z). As noted above, the token type for Token A 116A may be the same or different as the token type for Token B 116B. Moreover, the length indicated by token A data 204A may be different from the length indicated by token B data 204B.

As noted above, the high-level parser 108 may initially set byte pointer to 0, and may start processing the network packet 114 at byte 0 (e.g., such as header A 202A in the illustrative example). The high-level parser 108 may parse the network packet 114 in direction 206. The high-level parser 108 may identify header A 202A, which may correspond to the first byte in the header of the network packet. The high-level parser 108 may determines whether the token type indicated in header A 202A a known token type, such as by comparing the token type to a list of known token types stored in memory of the token processing system and/or high-level parser. The high-level parser 108 may then examine token A data 204, which may correspond to second byte in the header and contains the length of the token. If the high-level parser determines the length (e.g., length Y) matches its internal notion of the length associated with the token type, the high-level parser may then determine boundaries of token A 116A and trigger a corresponding low-level pointer.

After triggering a low-level parser associated with token A 116A, the high-level parser may update byte pointer 110 to comprise a value equal to the byte number associated with the end of token A 116A+1. In the illustrative example, after doing so, the high-level parser identifies token B 116B based on header B 202B. Accordingly, the high-level parser 108 may continue to parse the network packet 114, trigger additional low-level parser(s) in parallel to the low-level parser associated with token A 116A performing operations.

FIG. 2B illustrates an example environment 200B including exemplary inputs and outputs between components of the token processing system 106 in FIGS. 1 and 2A.

As illustrated in FIG. 2B, the environment 200B comprises high-level parser 108 and low-level parser(s) 112. In some examples, environment 200B corresponds to exemplary triggers being sent to multiple low-level parser(s), such that the low-level parser(s) operate in parallel with the high-level parser 108 in FIG. 2A. For instance, high-level parser 108 may send a first trigger 208A to a first low-level parser 112A. In some examples, the first trigger 208 may comprise a “KIND_trigger” to instruct the first low-level parser to process token A 116A. In some examples, the first trigger may comprise boundaries (e.g., such as <lo_ptr,hi_ptr>) within the packet buffer. When the high-level parser 108 identifies a token type associated with token B 116B, the high-level parser 108 may send a first trigger 208B to a second low-level parser 112B associated with the respective token type, to instruct the second low-level parser 112B to process the body (e.g., token B data 204B) of token B 116B. When the high-level parser 108 identifies a token type associated with token N 116N, the high-level parser 108 may send a first trigger 208N to a third low-level parser 112N associated with the respective token type, to instruct the third low-level parser 112N to process the body (e.g., token N data 204N) of token N 116N.

In the illustrative example, when the high-level parser 108 determines that the end of the network packet 114 is reached, the high-level parser 108 may send second trigger(s) to the low-level parser(s). For instance, the high-level parser 108 may send second trigger 210A to the first low-level parser 112A, second trigger 210B to the second low-level parser 112B, second trigger 210N to the third low-level parser 112N. In some examples, the second trigger(s) comprise an “input done” trigger that indicates that the end of the network packet 114 is reached and instructs the low-level parser(s) to provide respective output(s) when ready (e.g., when each respective token is processed).

In some examples, each low-level parser may output a trigger (not illustrated) to indicate that processing of the respective token data is complete. For instance, each low-level parser may assert a “token done” trigger (e.g., KIND_done) to the high-level parser 108 and/or token processing system 106 to indicate that it has it has completed its processing. In some examples, the low-level parser(s) may provide output data associated with the processed token contents. For instance, a first low-level parser may provide output data A 212A, the second low-level parser 112B may provide output data B 212B, and the third low-level parser 112N may provide output data N 212N. In some examples, output data A 212A may comprise a bit indicating that the token type associated with the first low-level parser 112A was seen in the network packet and output a value associated with processing the data of token A 116A. For instance,

As an example, the first low-level parser 112A may comprise a maximum segment size (MSS) option parser and may operate on a first token identified within a network packet. When the first low-level parser 112A receives the second trigger 210A from the high-level parser, the first low-level parser 112A may finish processing the first token (e.g., such as token A 116A) and may generate output data A 212A. In this example, output data A 212A may comprise (1) a number between 0-9000, indicating the maximum size of TCP packet to expect in the future and (2) a bit comprising a value (e.g., such as “1”) indicating that the MSS token type was seen within the network packet.

Output data B 212B may comprise a bit indicating that the token type associated with the second low-level parser 112B was seen and one or more values associated with processing token B 116B. For instance, where the second low-level parser 112B corresponds to a timestamp parser, the second low-level parser 112B may process the contents of token B 116B in segments. In this example, output data B 212B may comprise the bit and value(s) associated with each respective segment of the token B data 204B.

Output data N 212N may comprise a bit indicating that the token type associated with the third low-level parser 112N was seen and one or more values associated with processing token N 116N.

As noted above, the second trigger(s) are also sent to low-level parser(s) that are not triggered by the high-level parser to operate on a particular token. While not illustrated in FIG. 2B, these low-level parser(s) also output a bit indicating that the token type associated with the respective low-level parser was not seen within the network packet.

In some examples, the system may aggregate the output data (e.g., output data A 212A, output data B 212B, output data N 212N, etc.). Where output data from other low-level parser(s) 112 (e.g., low-level parser(s) not triggered by the high-level parser 108), indicate that one or more token types were not seen within a network packet, the system may insert default values. In some examples, the system may send the aggregated values to a next level of processing to enable the system to perform various actions (e.g., such as updating a state of the TCP, etc.). For instance, when all the low-level parsers have completed processing the token data (e.g., asserted their KIND_done output signals), the system may consume the outputs. In some examples, the high-level parser is then free to process the next network packet which is then allowed to stream into the packet buffer.

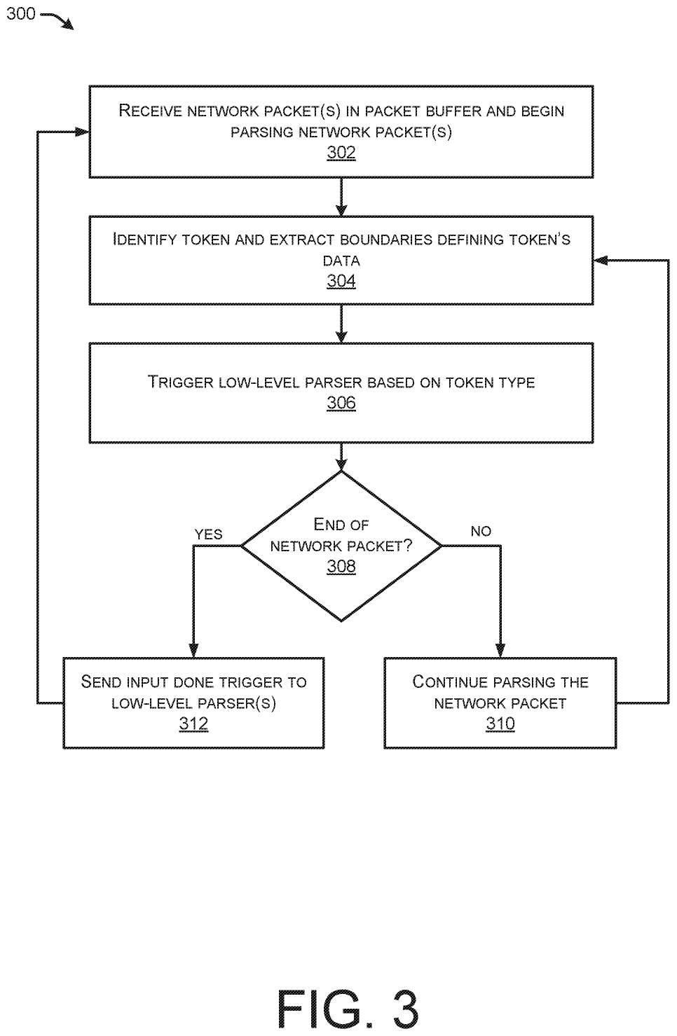

FIG. 3 illustrates a illustrates a flow diagram of an example system 300 for a high-level parser to perform processing of network packet(s) in parallel with low-level parser(s), in accordance with the systems and techniques described in FIGS. 1-2. In some instances, one or more of the steps of system 300 may be performed by a device 102, token processing system 106, and/or high-level parser 108, that includes one or more processors and one or more non-transitory computer-readable media storing computer-executable instructions that, when executed by the one or more processors, cause the one or more processors to perform operations of system 300.

At 302, the system may receive network packet(s) in a packet buffer and begin parsing the network packet(s). For instance, as described above, the high-level parser may internally maintains a byte pointer 110. When a new network packet is received in the packet buffer, the system may set (or reset) the byte pointer to “byte 0” within the packet buffer.

At 304, the system may identify a token and extract boundaries defining the token's data. In some examples, identifying the token comprises determining a token type associated with the token. In some examples, the token types (e.g., KINDs, such as KINDx, KINDy, KINDz, etc.) may each comprise a respective predetermined length. In some examples, the high-level parser may compare a token type indicated in the header of the network packet to the KINDs (e.g., such as a list stored in memory), and match the token type to a particular KIND. In some examples, such as where the high-level parser determines a token in an incoming packet does not match the known list of KINDs, the high-level parser may treat the token type as an unknown KIND, where the token may comprise an arbitrarily length (e.g., such as a length specified within the header).

When a new packet starts to stream into the packet buffer, the high-level parser identifies the token type byte which is usually the first byte in the header of the network packet. The system may then determines whether it is a known token type by comparing the token type to a list of known token types. The system may then examines the second byte in the header, which contains the length of the token. If the length matches its internal notion of the length associated with this particular token type, the high-level parser then identifies the <lo_ptr,hi_ptr> which define the byte boundaries of this particular token within the packet buffer.

At 306, the system may trigger a low-level parser based on a token type. For instance, as described above, when the high-level parser identifies a token, the high-level parser may identify a low-level parser associated with a token type corresponding to the token. The high-level parser may trigger the low-level parser to process the token by providing input to the low-level parser. In some examples, the input may comprise the boundaries (e.g., size, start point, end point, etc.) of the token. In some examples, the high-level parser does not process the contents of the token.

At 308, the system may determine whether the end of the network packet has been reached. For instance, the system may determine whether the network packet comprises anymore bytes.

Where the system determines that the end of the network packet has not been reached (step 308—NO), the system may proceed to 310. At 310, the system may continue parsing the network packet. For instance, the system may update the byte pointer to comprise a value equal to the value of previous token's end byte plus 1 (e.g., a value equal to high_ptr+1) within the current network packet.

Where the system determines that the end of the network packet has been reached (step 308—YES), the system may proceed to 312. At 312, the system may send input done trigger(s) to the low-level parser(s). For instance, the high-level parser may assert an “input done” trigger to the one or more low-level parsers, where the input done trigger indicates that the end of the network packet is reached and instructs the low-level parsers to provide respective output(s) when ready (e.g., when each token is processed).

In some examples, once output is aggregated from the low-level parser(s), the system may return to step 302, where a new network packet is streamed into the packet buffer.

In this way, the system comprises a decomposed design that allows high-level parsing activity to operate in parallel to the processing (and parsing) of various identified tokens.

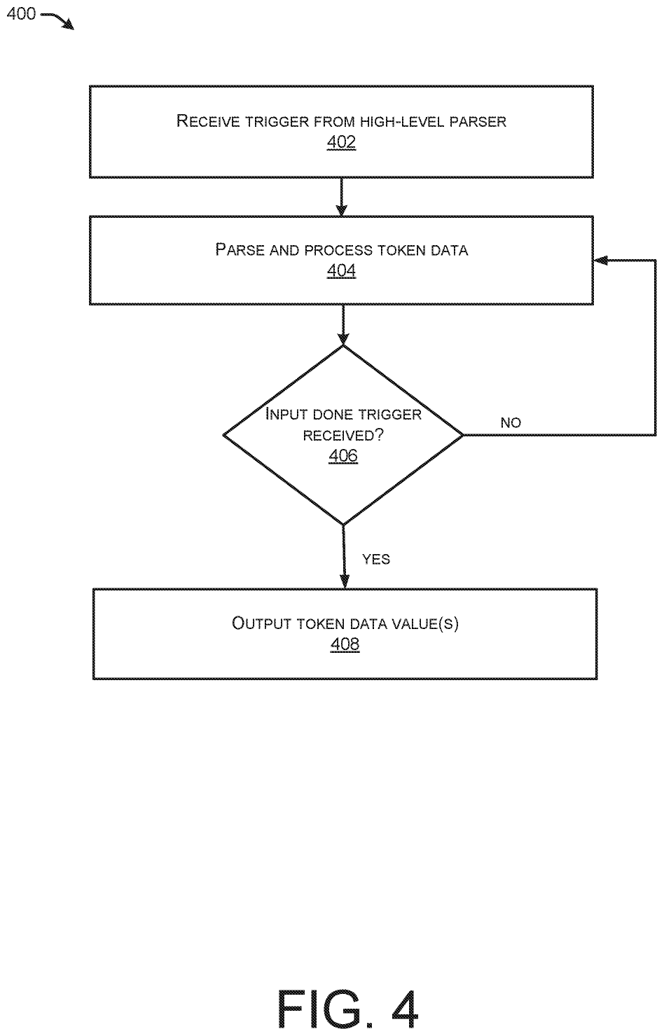

FIG. 4 illustrates a flow diagram of an example system 400 for a low-level parser to process token(s) and provide output in parallel with a high-level parser, in accordance with the systems and techniques described in FIGS. 1-3. In some instances, one or more of the steps of system 400 be performed by a device 102, token processing system 106, and/or high-level parser 108, that includes one or more processors and one or more non-transitory computer-readable media storing computer-executable instructions that, when executed by the one or more processors, cause the one or more processors to perform operations of system 400. In some examples, one or more of the steps of system 400 may be performed in conjunction with and/or in parallel to the one or more steps of system 300 of FIG. 3.

At 402, the system may receive a trigger from a high-level parser. For instance, the high-level parser may correspond to high-level parser 108. In some examples, the trigger corresponds to first trigger 208A described in FIG. 2B above. For instance, when the system (e.g., a low-level parser 112) receives a trigger, the system may begin to process the specified token's data bytes, defined by the transmitted trigger (e.g., such as a <lo_ptr,hi_ptr>, within the packet buffer).

At 404, the system may parse and process token data. As noted above, the actual processing of data bytes within each token varies based on token type. For some cases, we only need to extract the bytes and present them out. For other, processing of the data bytes might be called. As noted above, depending on token type, the data bytes within a token may be processed as a whole or in multiple segments.

At 406, the system may determine whether an input done trigger is received. For instance, the system may complete processing of the token data and may wait for the input done trigger, in order to output the token data value(s). Where the system determines that the input done trigger has not been received (step 406—NO), the system may return to step 404 to continue processing the token data.

Where the system determines that the input done trigger has been received (step 406—YES), the system may proceed to 108. At 408, the system may complete processing the token data and output token data value(s). As noted above, prior to outputting the token data value(s), the low-level parser(s) 112 may output a trigger indicating that processing of a particular token is complete. For instance, the token data value(s) may correspond to output data 212 described in FIG. 2B above. In some examples, the token data value(s) are output by low-level parser(s) that have been triggered by the high-level parser. In some examples, and as described above, the low-level parser(s) 112 may each output respective bit(s) (e.g., such as a valid bit) that indicates whether the token type was present or not within the network packet.

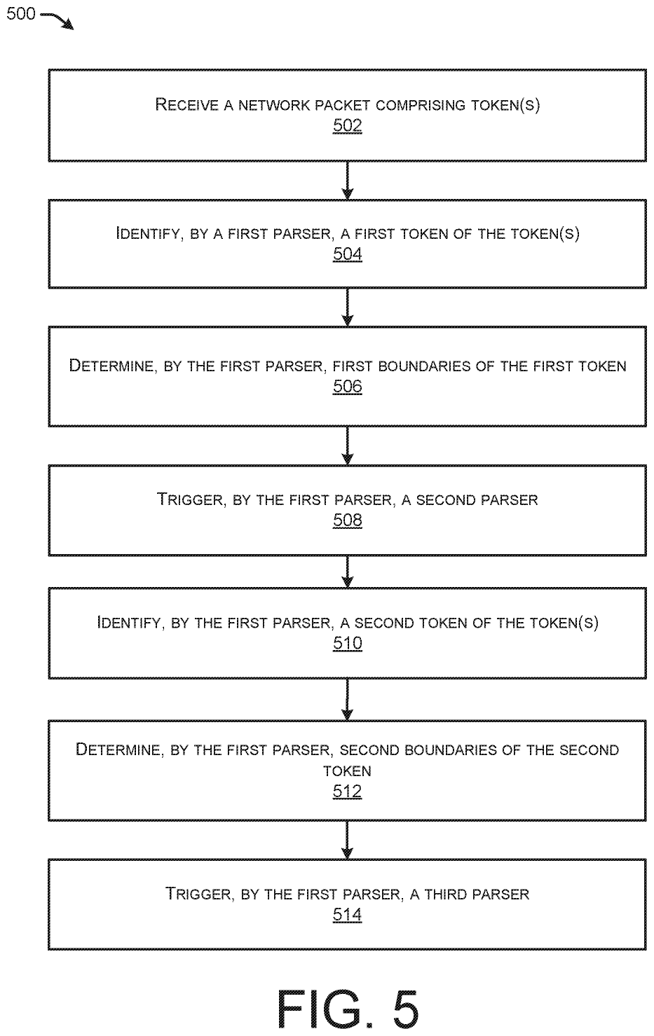

FIG. 5 illustrates a flow diagram of an example method 500 for a system to perform split-level processing of network packet(s) according to the techniques described in FIGS. 1-4. In some instances, one or more steps of the method 500 may be performed by a system (e.g., one or more devices), such as the token processing system 106, device 102, a combination thereof, and/or any other devices. The techniques of method 500 may be performed by a system that includes one processor, or more than one processor.

At 502, the system may receive a network packet comprising token(s). For instance, the system may correspond to token processing system 106. The network packet may comprise network packet 114 and the token(s) may correspond to token(s) 116. As noted above, the system may receive the network packet as a stream and may store the network packet in a packet buffer of the system.

At 504, the system may identify, by a first parser, a first token of the token(s). In some examples, the first parser comprises high-level parser 108. In some examples, identifying the first token comprises identifying the first token using a byte pointer, such as byte pointer 110.

At 506, the system may determine, by the first parser, first boundaries of the first token. In some examples, determining the first boundaries of the first token further comprise processing a header of the first token to determine token length and token data length.

At 508, the system may trigger, by the first parser, a second parser. In some examples, the second parser comprises a low-level parser 112. In some examples, triggering the second parser comprises determining the second parser based at least in part on the first token type and sending, to the second parser the first boundaries associated with the first token, wherein the first boundaries further comprise pointer attributes associated with the first token. For instance, the pointer attributes may comprise a first pointer to a first bit associated with the start of the token contents (e.g., body of the token) and a second pointer to a second bit associated with the end of the token contents. For instance, the pointer attributes may comprise <lo_ptr,hi_ptr> which define the byte boundaries of this particular token within the packet buffer.

At 510, the system may identify by the first parser, a second token of the token(s). In some examples, the first parser operates in parallel to the second parser.

At 512, the system may determine, by the first parser, second boundaries of the second token. In some examples, determining the second boundaries of the second token further comprise processing a header of the second token to determine token length and token data length.

At 514, the system may trigger, by the first parser, a third parser. In some examples, the second parser and the third parser comprise different per-token parser threads. For instance, the second parser may correspond to an MSS option parser and the third parser may correspond to a timestamp option parser. In some examples, the second parser and the third parser may process respective token data in parallel with the first parser operating on the network packet.

In some examples, the system may comprise identifying, by the first parser, an end of the network packet; and transmitting to the second parser and the third parser, a message indicating the end of the network packet is reached to cause the second parser and the third parser to output one or more values associated with processing each of the first token and the second token. For instance, the message may comprise an input done trigger.

In some examples, the system may further comprise identifying, by the first parser, a third token. The system may determine third boundaries of the third token, the third boundaries including a third token type. The system may determine that the third token type does not match a corresponding per-token parser. The system may trigger a fourth parser associated with an unknown token type, where the fourth parser refrains from processing token data associated with the third token.

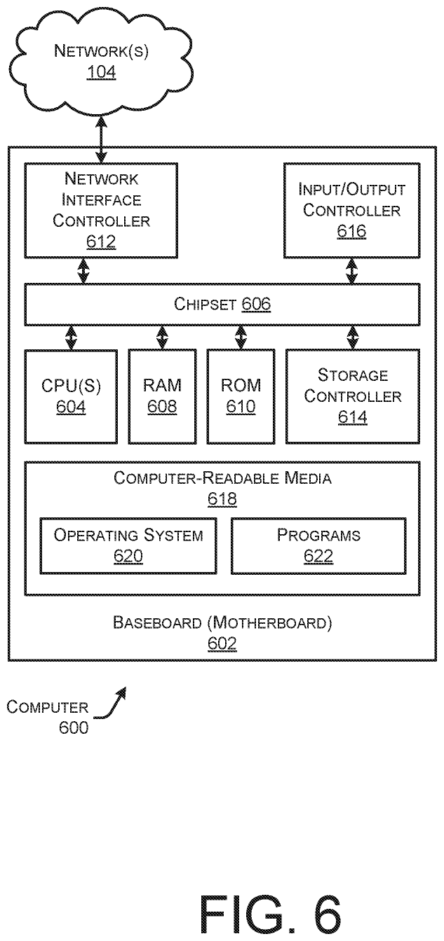

FIG. 6 shows an example computer architecture for a device capable of executing program components for implementing the functionality described above. The computer architecture shown in FIG. 6 illustrates any type of computer 600, such as a conventional server computer, workstation, desktop computer, laptop, tablet, network appliance, e-reader, smartphone, or other computing device, and can be utilized to execute any of the software components presented herein. The computer may, in some examples, correspond to a device 102 and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network 104. The chipset 606 can include functionality for providing network connectivity through a NIC 612, such as a gigabit Ethernet adapter. The NIC 612 is capable of connecting the computer 600 to other computing devices over the network(s) 104 and/or LAN. It should be appreciated that multiple NICs 612 can be present in the computer 600, connecting the computer to other types of networks and remote computer systems.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by the device 102 and/or any components included therein, may be supported by one or more devices similar to computer 600. Stated otherwise, some or all of the operations performed by device 102 and or any components included therein, may be performed by one or more computer devices.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes described above with regard to FIGS. 1-5. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in FIG. 6, can include other components that are not explicitly shown in FIG. 6, or might utilize an architecture completely different than that shown in FIG. 6.

As described herein, the computer 600 may comprise one or more of a device 102 and/or any other device. The computer 600 may include one or more hardware processors (processor(s), such as CPUs 604) configured to execute one or more stored instructions. The processor(s) may comprise one or more cores. Further, the computer 600 may include one or more network interfaces configured to provide communications between the computer 600 and other devices, such as the communications described herein as being performed by the device 102 and/or any other device. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 622 may comprise any type of programs or processes to perform the techniques described in this disclosure for signing and verifying packets sent through a network using hardware-based signatures. For instance, the programs 622 may cause the computer 600 to perform techniques including receiving a network packet comprising a plurality of tokens; identifying, by a first parser, a first token of the plurality of tokens; determining, by the first parser, first boundaries of the first token, the first boundaries including a first token type; triggering, by the first parser and based on the first token type, a second parser; identifying, by the first parser, a second token of the plurality of tokens; determining, by the first parser, second boundaries of the second token, the second boundaries including a second token type; and triggering, by the first parser and based on the second token type, a third parser.

In this way, the system provides a decomposed way of performing network protocol parsing using split-levels. For instance, by enabling the “high level” and “low-level” parsers to operate in parallel, the system provides improved performance and enables pipelining possibilities within hardware designs. Moreover, testing or verification of the system may now be decomposed into sub-units. For instance, a testing subunit that exercises the “high level” parser can generate various possible token headers, treating the data bytes as don't-cares. As long as the high-level parser extracts the header and the pointers defining each token correctly, the data can be treated as irrelevant at this level of testing and verification. Meanwhile, each low-level parser can be individually tested within a separate sub-unit where all variations of this specific type of token can be tested in isolation, thereby improving testability.

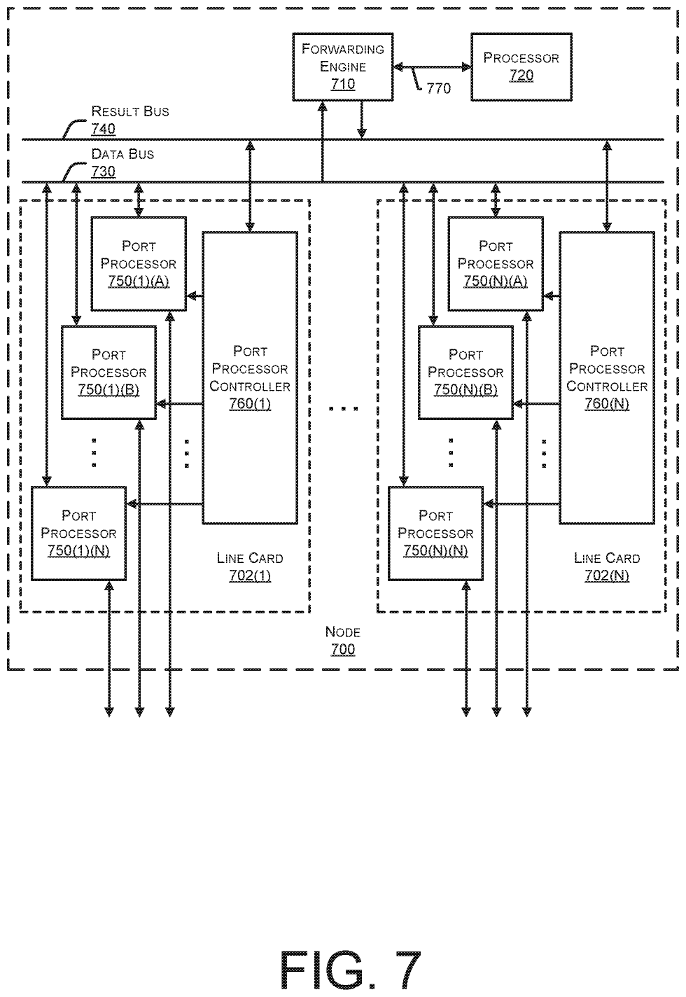

FIG. 7 illustrates a block diagram illustrating certain components of an example node 700 that can be utilized to implement various aspects of the technologies disclosed herein. In some examples, node(s) 700 may be employed in various networks, such as, for example, network 104 as described with respect to FIGS. 1-5.

In some examples, node 700 may include any number of line cards 702 (e.g., line cards 702(1)-(N), where N may be any integer greater than 1) that are communicatively coupled to a forwarding engine 710 (also referred to as a packet forwarder) and/or a processor 720 via a data bus 730 and/or a result bus 740. Line cards 702(1)-(N) may include any number of port processors 750(1)(A)-(N)(N) which are controlled by port processor controllers 560(1)-(N), where N may be any integer greater than 1. Additionally, or alternatively, forwarding engine 710 and/or processor 720 are not only coupled to one another via the data bus 730 and the result bus 740, but may also communicatively coupled to one another by a communications link 770.

The processors (e.g., the port processor(s) 750 and/or the port processor controller(s) 760) of each line card 702 may be mounted on a single printed circuit board. When a packet or packet and header are received, the packet or packet and header may be identified and analyzed by node 700 (also referred to herein as a router) in the following manner. Upon receipt, a packet (or some or all of its control information) or packet and header may be sent from one of port processor(s) 750(1)(A)-(N)(N) at which the packet or packet and header was received and to one or more of those devices coupled to the data bus 730 (e.g., others of the port processor(s) 750(1)(A)-(N)(N), the forwarding engine 710 and/or the processor 720). Handling of the packet or packet and header may be determined, for example, by the forwarding engine 710. For example, the forwarding engine 710 may determine that the packet or packet and header should be forwarded to one or more of port processors 750(1)(A)-(N)(N). This may be accomplished by indicating to corresponding one(s) of port processor controllers 760(1)-(N) that the copy of the packet or packet and header held in the given one(s) of port processor(s) 750(1)(A)-(N)(N) should be forwarded to the appropriate one of port processor(s) 750(1)(A)-(N)(N). Additionally, or alternatively, once a packet or packet and header has been identified for processing, the forwarding engine 710, the processor 720, and/or the like may be used to process the packet or packet and header in some manner and/or may add packet security information in order to secure the packet. On a node 700 sourcing such a packet or packet and header, this processing may include, for example, encryption of some or all of the packet's or packet and header's information, the addition of a digital signature, and/or some other information and/or processing capable of securing the packet or packet and header. On a node 700 receiving such a processed packet or packet and header, the corresponding process may be performed to recover or validate the packet's or packet and header's information that has been secured.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method implemented at least in part by hardware circuitry, the method comprising:
receiving a network packet comprising a plurality of tokens;
identifying, by a first parser, a first token of the plurality of tokens;
determining, by the first parser, first boundaries of the first token, the first boundaries including a first token type;
triggering, by the first parser and based on the first token type, a second parser;
identifying, by the first parser, a second token of the plurality of tokens;
determining, by the first parser, second boundaries of the second token, the second boundaries including a second token type; and
triggering, by the first parser and based on the second token type, a third parser.

2. The method of claim 1, wherein the first boundaries of the first token further comprise processing a header of the first token to determine token length and token data length.

3. The method of claim 1, wherein the first parser operates in parallel to one or more of the second parser and the third parser.

4. The method of claim 1, wherein identifying the first token comprises identifying the first token using a byte pointer.

5. The method of claim 1, wherein triggering the second parser comprises:
determining the second parser based at least in part on the first token type; and
sending, to the second parser the first boundaries associated with the first token, wherein the first boundaries further comprise pointer attributes associated with the first token.

6. The method of claim 1, wherein the first parser comprises a high-level parser thread.

7. The method of claim 1, wherein the second parser and the third parser comprise different per-token parser threads.

8. The method of claim 1, further comprising:
identifying, by the first parser, an end of the network packet; and
transmitting to the second parser and the third parser, a message indicating the end of the network packet is reached to cause the second parser and the third parser to output one or more values associated with processing each of the first token and the second token.

9. The method of claim 1, further comprising:
identifying, by the first parser, a third token,
determining, third boundaries of the third token, the third boundaries including a third token type;
determining, that the third token type does not match a corresponding per-token parser; and
triggering a fourth parser associated with an unknown token type, where the fourth parser refrains from processing token data associated with the third token.

10. A system, comprising;
one or more processors; and
one or more non-transitory computer-readable media storing instructions executable by the one or more processors, wherein the instructions program the one or more processors to perform operations comprising:
receiving a network packet comprising a plurality of tokens;
identifying, by a first parser, a first token of the plurality of tokens;
determining, by the first parser, first boundaries of the first token, the first boundaries including a first token type;
triggering, by the first parser and based on the first token type, a second parser;
identifying, by the first parser, a second token of the plurality of tokens;
determining, by the first parser, second boundaries of the second token, the second boundaries including a second token type; and
triggering, by the first parser and based on the second token type, a third parser.

11. The system of claim 10, wherein the first boundaries of the first token further comprise processing a header of the first token to determine token length and token data length.

12. The system of claim 10, wherein the first parser operates in parallel to one or more of the second parser and the third parser.

13. The system of claim 10, wherein identifying the first token comprises identifying the first token using a byte pointer.

14. The system of claim 10, wherein triggering the second parser comprises:
determining the second parser based at least in part on the first token type; and
sending, to the second parser the first boundaries associated with the first token, wherein the first boundaries further comprise pointer attributes associated with the first token.

15. The system of claim 10, wherein the second parser and the third parser comprise different per-token parser threads.

16. The system of claim 10, the operations further comprising:
identifying, by the first parser, an end of the network packet; and
transmitting to the second parser and the third parser, a message indicating the end of the network packet is reached to cause the second parser and the third parser to output one or more values associated with processing each of the first token and the second token.

17. The system of claim 10, the operations further comprising:
identifying, by the first parser, a third token,
determining, third boundaries of the third token, the third boundaries including a third token type;
determining, that the third token type does not match a corresponding per-token parser; and
triggering a fourth parser associated with an unknown token type, where the fourth parser refrains from processing token data associated with the third token.

18. The system of claim 10, wherein the first parser comprises a high-level parser thread.

19. One or more non-transitory computer-readable media maintaining instructions that, when executed by one or more processors, program the one or more processors to perform operations comprising:
receiving a network packet comprising a plurality of tokens;
identifying, by a first parser, a first token of the plurality of tokens;
determining, by the first parser, first boundaries of the first token, the first boundaries including a first token type;
triggering, by the first parser and based on the first token type, a second parser;
identifying, by the first parser, a second token of the plurality of tokens;
determining, by the first parser, second boundaries of the second token, the second boundaries including a second token type; and
triggering, by the first parser and based on the second token type, a third parser.

20. The one or more non-transitory computer-readable media of claim 19, wherein the first parser operates in parallel to one or more of the second parser and the third parser.
